(19) United States
(12) Patent Application Publication
(10) Pub. No.: US 2025/0091229 A1
(43) Pub. Date: Mar. 20, 2025

(54) ROBOT HAND AND OPERATION METHOD FOR ROBOT HAND

(71) Applicant: Panasonic Holdings Corporation, Osaka (JP)

(72) Inventors: Hiroki IKEUCHI, Osaka (JP); Yoshitatsu ASAMA, Osaka (JP); Yu KANEDA, Nara (JP); Tetsuyou WATANABE, Ishikawa (JP); Toshihiro NISHIMURA, Ishikawa (JP); Tsubasa MURYOE, Ishikawa (JP)

(21) Appl. No.: 18/964,124

(22) Filed: Nov. 29, 2024

Related U.S. Application Data
(63) Continuation of application No. PCT/JP2023/003201, filed on Feb. 1, 2023.

(30) Foreign Application Priority Data
May 31, 2022 (JP) 2022-088819

(51) Int. Cl. B25J 15/08; B25J 15/02

(52) U.S. Cl. CPC B25J 15/08; B25J 15/0266

(57) ABSTRACT

A robot hand including: a first finger member; an intermediate member that is rotatably connected to the first finger member; a second finger member that is rotatably connected to the intermediate member; and a guide member that is rotatably connected to the second finger member and includes a first guider. The first finger member includes a first guide follower that is rotatably and movably disposed in the first guider.

### TECHNICAL FIELD

The present disclosure relates to a robot hand and an operation method for a robot hand.

### BACKGROUND ART

A robot hand adopting an inferior drive mechanism has been proposed. By adopting the inferior drive mechanism in the robot hand, it is possible to move a large number of joints with a small number of actuators, and it is possible to make the configuration of the entire robot hand simple. According to the robot grasper disclosed in PTL 1, it is possible to lift up an object by matching, to the shape of the object, a finger including a base link, a forward link, a rearward link, and a fingertip link.

### CITATION LIST

### Patent Literature

### PTL 1

Japanese Patent No. 6689872

### SUMMARY OF INVENTION

### Technical Problem

It is desired to improve the usability of a robot hand while adopting an inferior drive mechanism.

An object of the present disclosure is to improve the usability of a robot hand.

A robot hand according to the present disclosure includes: a first finger member; an intermediate member that is rotatably connected to the first finger member; a second finger member that is rotatably connected to the intermediate member; and a guide member that is rotatably connected to the second finger member and includes a first guider. The first finger member includes a first guide follower that is rotatably and movably disposed in the first guider.

An operation method according to the present disclosure is a method for a robot hand, the method including: disposing, along one straight line, a first finger member including a first guide follower, an intermediate member rotatably connected to the first finger member, a second finger member rotatably connected to the intermediate member, and a guide member rotatably connected to the second finger member and including a first guider; rotating the first finger member with respect to the intermediate member in a first rotation direction while moving the first guide follower along the first guider; and rotating the second finger member with respect to the intermediate member in a second rotation direction which is a direction opposite to the first rotation direction.

### Advantageous Effects of Invention

According to the present disclosure, it is possible to improve the usability of a robot hand.

### BRIEF DESCRIPTION OF DRAWINGS

FIG. 1 is a side view of a robot hand in an insertion mode;

FIG. 2 is a side view of the robot hand in a mode transition;

FIG. 3 is a side view of the robot hand in a state in which the transition to the grip mode is completed;

FIG. 4 is a side view of the robot hand during the gripping operation;

FIG. 5 is a state transition diagram of the robot hand in the case where an external force is applied to a second finger member;

FIG. 6 is a state transition diagram of the robot hand in the case where an external force is applied to the second finger member;

FIG. 7 is a state transition diagram of the robot hand in the case where an external force is applied to the second finger member;

FIG. 8 is a state transition diagram of the robot hand in the case where an external force is applied to the second finger member;

FIG. 9 is a state transition diagram of the robot hand that illustrates a gripping operation performed while being inserted into a narrow gap;

FIG. 10 is a state transition diagram of the robot hand that illustrates a gripping operation performed while being inserted into a narrow gap;

FIG. 11 is a state transition diagram of the robot hand that illustrates a gripping operation performed while being inserted into a narrow gap;

FIG. 12 is a state transition diagram of the robot hand that illustrates a gripping operation performed while being inserted into a narrow gap;

FIG. 13 is a state transition diagram of the robot hand that illustrates a gripping operation performed while being inserted into a narrow gap;

FIG. 14 is an enlarged view of a first finger member and an intermediate member;

FIG. 15 is an enlarged view of the first finger member and a link member; and

FIG. 16 is an enlarged view of the first finger member and the link member.

### DESCRIPTION OF EMBODIMENTS

The following is a description of the form of this disclosure with reference to the drawings.

### Structure and Operation Example

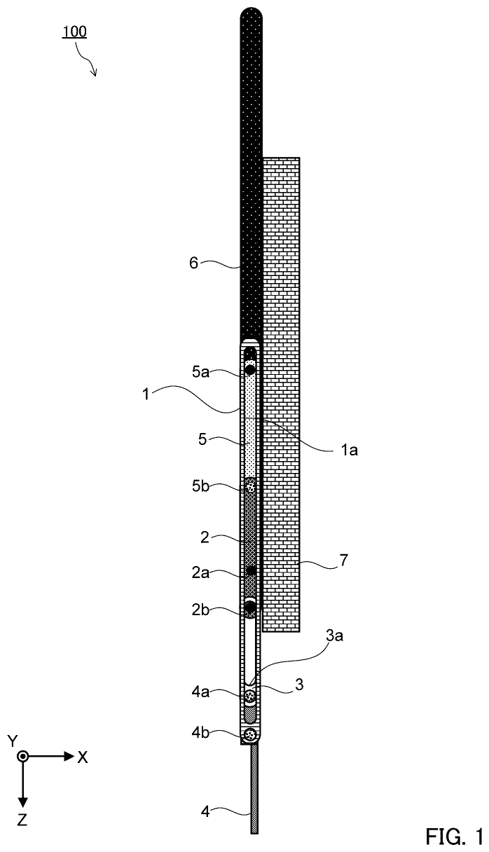

FIG. 1 is a side view of robot hand 100 according to an aspect of the present disclosure. FIG. 1 illustrates a state in which robot hand 100 is in an insertion mode. Robot hand 100 includes guide member 1, first finger member 2, intermediate member 3, second finger member 4, link member 5, driver 6, and stopper 7.

Guide member 1 is a long member that extends in one direction. Hereinafter, the extending direction of guide member 1 will be described as the Z direction. Further, one direction orthogonal to the Z direction will be described as the X direction, and a direction orthogonal to the Z direction and X direction will be described as the Y direction. The X, Y, and Z directions are directions along the X-axis, Y-axis, and Z-axis, respectively, which configure a rectangular coordinate system.

Guide member 1 may be a rod-shaped member that extends in the Z direction, or may be a flat plate-shaped member that extends along the YZ plane.

Guide member 1 includes first guider 1a that linearly extends in the extending the direction of guide member 1 (that is, the Z direction). First guider 1a is, for example, a slot having a bottom, or a through-hole which is long in length.

First finger member 2 is a long member that extends in one direction. First finger member 2 is disposed to overlap with guide member 1 in the Y direction in the insertion mode. First finger member 2 may be a rod-shaped member or a flat plate-shaped member.

First finger member 2 includes first guide follower 2a that protrudes in the Y direction. First guide follower 2a is rotatably and movably disposed in first guider 1a. First guide follower 2a is, for example, a pin.

First finger member 2 includes second guide follower 2b that protrudes in the Y direction. Second guide follower 2b is, for example, a pin.

Intermediate member 3 is a long member that extends in one direction. Intermediate member 3 is disposed to overlap with guide member 1 in the Y direction in the insertion mode. Intermediate member 3 may be a rod-shaped member or a flat plate-shaped member.

Intermediate member 3 includes second guider 3a that linearly extends in the extending direction of intermediate member 3. Second guider 3a is, for example, a slot having a bottom or a through-hole which is long in length.

Second guide follower 2b is rotatably and movably disposed in second guider 3a. With second guide follower 2b rotatably disposed in second guider 3a, intermediate member 3 is rotatably connected to first finger member 2. Intermediate member 3 is connected to one end of first finger member 2.

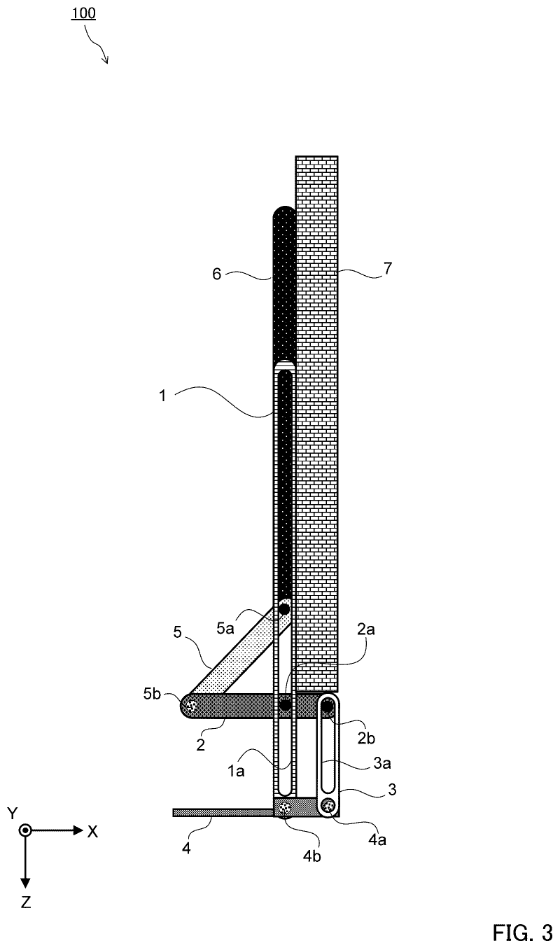

First finger member 2 and intermediate member 3 are configured to restrain the movement of second guide follower 2b in second guider 3a when first finger member 2 and intermediate member 3 are disposed such that first finger member 2 and intermediate member 3 are disposed along a straight line (see FIG. 1). That is, in the state illustrated in FIG. 1, first finger member 2 cannot move relative to intermediate member 3 in the Z direction. Further, second guide follower 2b is allowed to move in second guider 3a when first finger member 2 and intermediate member 3 are disposed orthogonal to each other (see FIG. 3). That is, in the state illustrated in FIG. 3, first finger member 2 can relatively move in the Z direction with respect to intermediate member 3.

Second finger member 4 is a long member that extends in one direction. A part of second finger member 4 is disposed to overlap with guide member 1 in the Y direction in the insertion mode. Second finger member 4 may be a rod-shaped member or a flat plate-shaped member.

Second finger member 4 is rotatably connected to intermediate member 3. Second finger member 4 is connected, at an end of second finger member 4, to an end of intermediate member 3.

The connecting mechanism between second finger member 4 and intermediate member 3 may be any mechanism as long as second finger member 4 and intermediate member 3 are rotatable with respect to each other. This connecting mechanism may be, for example, formed such that pin 4a extended in the Y direction from second finger member 4 is inserted into a through-hole extended in the Y direction and formed in intermediate member 3.

Second finger member 4 is rotatably connected to guide member 1. Between the end portions of second finger member 4, that is, in an intermediate portion of second finger member 4, second finger member 4 is connected to the end portion of guide member 1.

The connection mechanism between second finger member 4 and guide member 1 may be any mechanism as long as second finger member 4 and guide member 1 are rotatable with respect to each other. This connecting mechanism may be, for example, formed such that pin 4b extended in the Y direction from second finger member 4 is inserted into a through-hole formed in guide member 1 extended in the Y direction.

Link member 5 is a long member that extends in one direction. Link member 5 is disposed to overlap with guide member 1 in the Y direction in the insertion mode. Link member 5 may be a rod-shaped member or a flat plate-shaped member.

Link member 5 includes third guide follower 5a that protrudes in the Y direction. Third guide follower 5a is rotatably and movably disposed in first guider 1a. Third guide follower 5a is, for example, a pin.

Link member 5 is rotatably connected to first finger member 2. The Link member 5 is connected, at an end of link member 5, to an end of first finger member 2.

The connection mechanism between link member 5 and first finger member 2 may be any mechanism as long as link member 5 and first finger member 2 are rotatable with respect to each other. This connecting mechanism may be, for example, formed such that pin 5b extended in the Y direction from link member 5 is inserted into a through-hole formed in first finger member 2 and extended in the Y direction.

Driver 6 is a long member that extends in one direction. A part of driver 6 is disposed to overlap with guide member 1 in the Y direction in the insertion mode. Driver 6 may be a rod-shaped member or a flat plate-shaped member.

Driver 6 is configured to be linearly moved along the extending direction of guide member 1 (that is, the Z direction) by the actuator. The actuator that moves driver 6 may have a rack-and-pinion mechanism that operates with a motor, or include a fluid pressure cylinder that operates with an operating fluid such as air or oil, for example.

Driver 6 is rotatably connected to link member 5. Driver 6 is connected, at an end of driver 6, to an end of link member 5.

The connection mechanism between driver 6 and link member 5 may be any mechanism as long as driver 6 and link member 5 are rotatable with respect to each other. This connecting mechanism may be, for example, formed such that a pin extended in the Y direction from driver 6 is inserted into a through-hole formed in link member 5 and extended in the Y direction. This pin may be composed of third guide follower 5a. In other words, link member 5 and driver 6 may be rotatably connected to each other by third guide follower 5a disposed in first guider 1a.

Stopper 7 is a block-shaped or thick plate-shaped member that extends in the extending the direction of guide member 1 (that is, the Z direction). Stopper 7 is disposed to overlap with guide member 1 in the X direction. Stopper 7 may be disposed in contact with guide member 1. Stopper 7 is fixed so as not to relatively move with respect to guide member 1 at least in a part thereof. The thickness of stopper 7 (that is, the dimension in the X direction, which is the direction in which guide member 1 and stopper 7 overlap) is set such that the distance from the center of first guide follower 2a to the rear surface of stopper 7 is equal to or larger than the center-to-center distance between first guide follower 2a and second guide follower 2b. The rear surface of stopper 7 is a surface located on one surface of stopper 7 on the rear side that faces guide member 1.

Stopper 7 is made of a material, for example, rubber, that is elastically deformable. When an external force in the direction in which guide member 1 and stopper 7 overlap (that is, the X direction) is applied, stopper 7 is relatively easily bent and deformed, and when this external force is no longer applied, stopper 7 returns to the original shape (that is, the shape illustrated in FIG. 1). When an external force is applied to the extending direction of stopper 7 (that is, the Z direction), on the other hand, stopper 7 is hardly deformed, and even when stopper 7 is deformed, the amount of deformation is small.

Robot hand 100 configured as described above operates as follows.

First, as illustrated in FIG. 1, guide member 1, first finger member 2, intermediate member 3, second finger member 4, link member 5, and driver 6 are disposed along one straight line. When the extending direction of guide member 1 is defined as the Z direction, guide member 1, first finger member 2, intermediate member 3, second finger member 4, link member 5, and driver 6 are disposed in a manner aligned along one straight line. Such an arrangement can be achieved by moving driver 6 in a direction away from first finger member 2 and second finger member 4 by means of an actuator.

The actuator is operated in this state to move driver 6 in the Z direction. Specifically, driver 6 is moved relative to guide member 1 so as to approach first finger member 2 and second finger member 4. Then, driver 6 pushes link member 5 in the Z direction via the connection mechanism between driver 6 and link member 5 (which may be third guide follower 5a). Link member 5 presses first finger member 2 in the Z direction via pin 5b. First finger member 2 presses intermediate member 3 in the Z direction via second guide follower 2b, where the movement within the second guider 3a is restricted. Intermediate member 3 presses second finger member 4 in the Z direction via pin 4a.

Second finger member 4 is rotatably connected to guide member 1 by pin 4b, but cannot move relative to guide member 1 in the Z direction.

Accordingly, at least one of first finger member 2, second finger member 4, and link member 5 relatively rotates with respect to guide member 1.

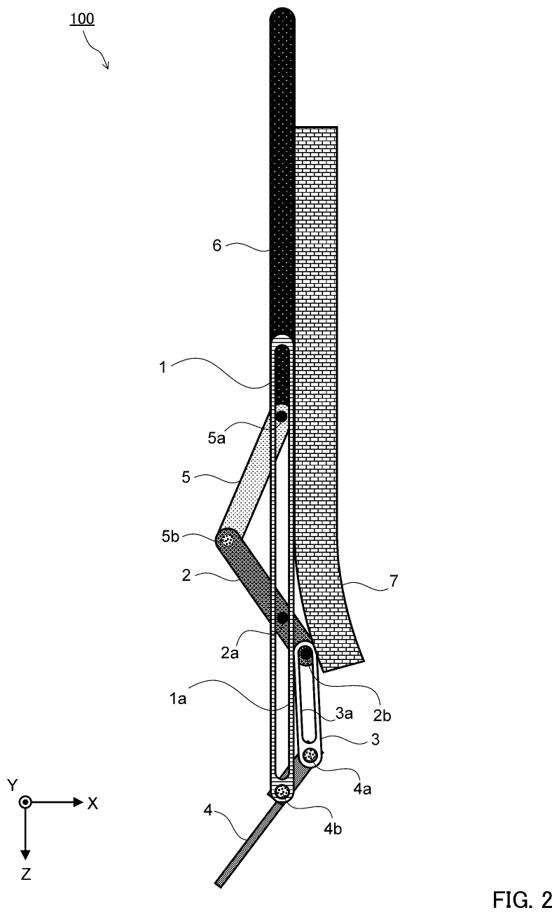

Subsequently, further movement of driver 6 in the Z direction sets robot hand 100 to a state illustrated in FIG. 2. FIG. 2 illustrates a state in which robot hand 100 is in mode transition.

At this time, driver 6, link member 5, first finger member 2, intermediate member 3, and second finger member 4 are set to a state where they are bent with respect to the members to which they are connected.

Specifically, first finger member 2 rotates in the first rotation direction with respect to intermediate member 3 while moving first guide follower 2a along first guider 1a. In the state illustrated in FIG. 2, the first rotation direction is the counterclockwise direction. The rotation center of the rotation of first finger member 2 with respect to intermediate member 3 is second guide follower 2b.

Further, second finger member 4 rotates with respect to intermediate member 3 in the second rotation direction. The second rotation direction is the direction opposite to the first rotation direction, and is the clockwise direction in the state illustrated in FIG. 2. The rotation center of second finger member 4 with respect to intermediate member 3 is pin 4a. Note that, second finger member 4 rotates in the second rotation direction with respect to guide member 1. The rotation center of second finger member 4 with respect to guide member 1 is pin 4b.

Further, link member 5 rotates in the second rotation direction with respect to first finger member 2 and driver 6 while moving third guide follower 5a along first guider 1a. The rotation center of link member 5 with respect to first finger member 2 is pin 5b. The rotation center of link member 5 with respect to driver 6 is a connection mechanism between driver 6 and link member 5 (which may be third guide follower 5a).

When first finger member 2 moves while rotating, at least one of first finger member 2 and intermediate member 3 presses the side surface of stopper 7 that faces guide member 1. The force that presses stopper 7 has an X direction component. As such, stopper 7 elastically deforms so as to be bent in the X direction. Since stopper 7 is bent, one end (the end at which second guide follower 2b is disposed) of first finger member 2 can be moved to the opposite side of the other end (the end at which pin 5b is disposed) of first finger member 2 with guide member 1 sandwiched therebetween. That is, since stopper 7 is bent, first finger member 2 can be easily rotated around first guide follower 2a and can move while sliding on the surface of stopper 7 in contact with stopper 7.

Note that, stopper 7 may have a long shape extending along guide member 1 to prevent link member 5 from rotating in the first rotation direction with respect to driver 6. Further, stopper 7 may be configured to prevent driver 6 from rotating around third guide follower 5a with respect to guide member 1. That is, stopper 7 may be configured to guide driver 6 such that driver 6 can move in the Z direction. For example, stopper 7 may have a shape that is in line contact with or surface contact with driver 6, and may be disposed to be in line contact with or surface contact with driver 6.

When first finger member 2 rotates around first guide follower 2a, intermediate member 3 moves in the X direction in conjunction with second guide follower 2b moving in the X direction. Then, the end of first finger member 2 corresponding to the fingertip, that is, the end in which pin 5b is disposed, moves in the −X direction. In other words, the fingertip of first finger member 2 protrudes.

In conjunction with the rotation and movement of first finger member 2 and the movement of intermediate member 3, second finger member 4 rotates. Then, the end corresponding to the fingertip of the second finger member 4, that is, the end that is not the end at which pin 4a is disposed, moves in the −X direction. In other words, the fingertip of second finger member 4 protrudes.

Note that, the rotation of first finger member 2 and the rotation of second finger member 4 are closely related to each other, and there is no master-slave relationship between these rotations. That is, first finger member 2 rotates in conjunction with rotation of second finger member 4, and second finger member 4 rotates in conjunction with rotation of first finger member 2.

When first finger member 2 and second finger member 4 each rotate 90 degrees from the state illustrated in FIG. 1, the rotation of first finger member 2 and second finger member 4 is completed, and the mode transition from the insertion mode to the transition mode is completed. In other words, the transition to the transition mode is placing first finger member 2 and the second finger member parallel to each other.

FIG. 3 illustrates a state in which the transition to the grip mode of robot hand 100 is completed, that is, a state in which the rotation of first finger member 2 and second finger member 4 is completed.

The distance from the connecting portion between first finger member 2 and the link member 5 (that is, pin 5b) to the first guide follower 2a is set to a dimension with which a right-angled triangle is drawable with three line segments connecting three points of the first guide follower 2a, the connecting portion between first finger member 2 and the link member (that is, pin 5b), and third guide follower 5a. When the link member 5 rotates in the second rotation direction with respect to first finger member 2 while third guide follower 5a is moved along the first guider 1a, the three line segments connecting third guide follower 5a, pin 5b and second guide follower 2b are in a state of drawing a right-angled triangle. At this time, first finger member 2 cannot rotate further with respect to link member 5. Further, first finger member 2 is in a state of being orthogonal to guide member 1. Thus, it is possible to easily set first finger member 2 to a state orthogonal to guide member 1 by only moving driver 6. Further, at the same time, it is possible to set second finger member 4 to a state of being orthogonal to guide member 1.

The distance between the connecting portion of first finger member 2 and intermediate member 3 (that is, second guide follower 2b) and first guide follower 2a is equal to the distance between the connecting portion of intermediate member 3 and second finger member 4 (that is, pin 4b) and the connecting portion of second finger member 4 and guide member 1 (that is, pin 4b). Accordingly, when the rotation of first finger member 2 and second finger member 4 is completed, intermediate member 3 becomes parallel to guide member 1. Further, intermediate member 3 and stopper 7 are configured such that one end of intermediate member 3 makes contact with the end surface of stopper 7 in the Z direction.

Further, when the rotation of first finger member 2 and second finger member 4 is completed, the force applied from driver 6 is no longer consumed for rotating each member. Accordingly, when the rotation of first finger member 2 and second finger member 4 is completed, driver 6 can apply a larger Z direction force to first finger member 2 via link member 5 than when the rotation of first finger member 2 and second finger member 4 is completed. When a large force is applied to first finger member 2, the constraint of second guide follower 2b in second guider 3a is released, and second guide follower 2b is freely movable in second guider 3a. That is, first finger member 2 is movable in the Z direction.

Further, the three line segments connecting third guide follower 5a, pin 5b, and second guide follower 2b draw a right-angled triangle. Accordingly, when a force in the Z direction is applied to third guide follower 5a, link member 5 and first finger member 2 can move in the Z direction while maintaining the right-angled triangular shape. That is, it is possible to relatively move first finger member 2 with respect to guide member 1 with first finger member 2 maintaining a posture orthogonal to guide member 1.

Accordingly, when a force in the Z direction is further applied to driver 6 in the state illustrated in FIG. 3, driver 6 moves in the Z direction. When driver 6 moves in the Z direction, first finger member 2 moves to approach second finger member 4 while maintaining a posture orthogonal to guide member 1, i.e., a posture in parallel with second finger member 4 (that is, first finger member 2 performs a translational motion).

Further, before the completion of the rotation of first finger member 2, the movement of second guide follower 2b in second guider 3a is constrained. When after the completion of the rotation of first finger member 2, the movement of second guide follower 2b in second guider 3a is allowed. Thus, as illustrated in FIGS. 1 and 2, in the movement mode or during the mode transition second guide follower 2b does not move in second guider 3a, each part can be smoothly bent with respect to each other, and robot hand 100 can be smoothly transitioned to the grip mode. Further, in the transition mode, first finger member 2 can be brought closer to or moved away from second finger member 4.

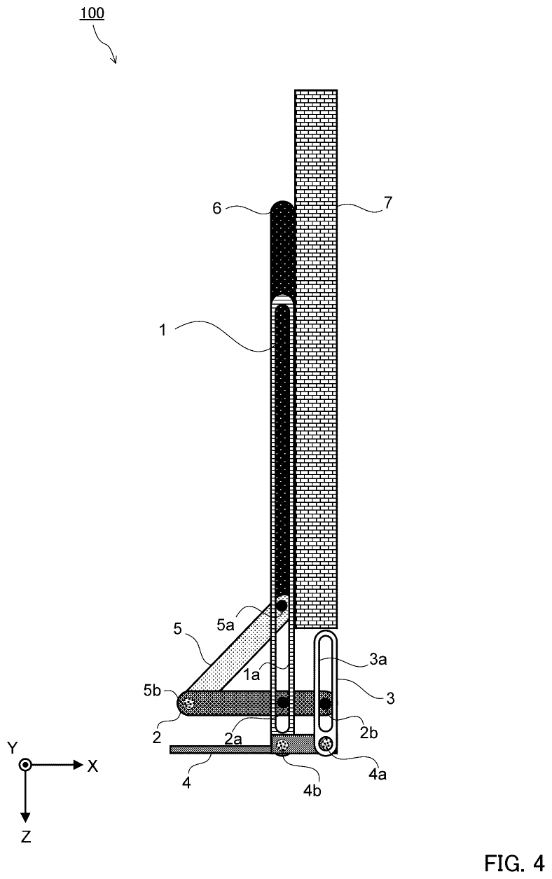

FIG. 4 illustrates a state of robot hand 100 in the gripping operation, that is, a state in which first finger member 2 is moved to approach second finger member 4, or a state in which the movement of first finger member 2 is completed. Intermediate member 3 and guide member 1 are disposed parallel to each other, and first finger member 2 approaches second finger member 4. In this manner, robot hand 100 can grip the target object between first finger member 2 and second finger member 4.

Robot hand 100 can be used in various postures, for example, in a posture in which second finger member 4 is lower than first finger member 2. In this case, second finger member 4 supports the target object from below. For example, in the case where the Z direction is the vertical direction, second finger member 4 supports the target object from directly below. In this case, the target object pushes second finger member 4 in the Z direction (that is, downward). Accordingly, a force of rotating second finger member 4 in the first rotation direction around pin 4b, that is, a force of causing second finger member 4 to hang down is applied to second finger member 4.

However, one end (one end on upper side) of intermediate member 3 coupled to second finger member 4 via pin 4a is in contact with stopper 7. When a force of rotating second finger member 4 in the first rotation direction (counterclockwise direction) around pin 4b is applied to the second finger, intermediate member 3 is pushed by the force toward stopper 7. At this time, stopper 7 holds intermediate member 3 so that intermediate member 3 does not relatively move with respect to guide member 1. That is, a reaction is applied to intermediate member 3. Accordingly, second finger member 4 does not rotate. That is, second finger member 4 can support the target portion without rotating pin 4b around the rotation center. Further, robot hand 100 can surely grasp the target object with first finger member 2 and second finger member 4.

### Other Operation Example

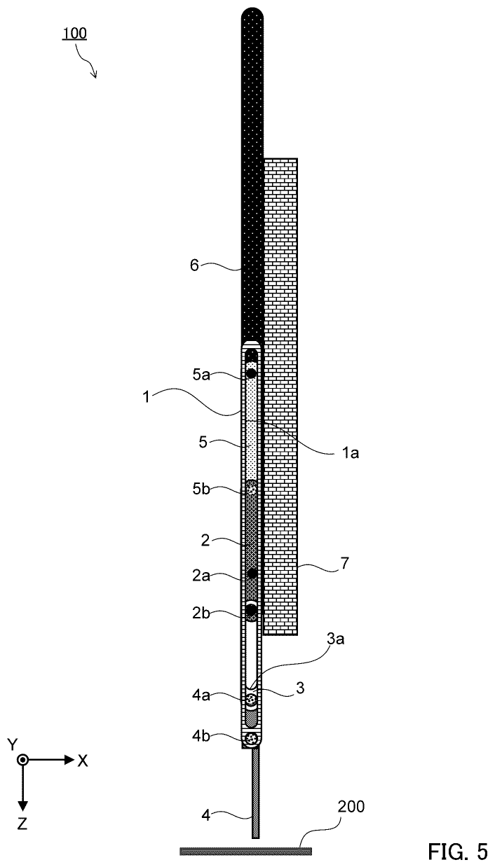

Next, another operation example of robot hand 100 will be described with reference to FIGS. 5 to 8. When referring to FIGS. 5 to 8, the Z direction may be described as the up-down direction, the X direction as the front-rear direction, and the Y direction as the left-right direction.

FIG. 5 illustrates a state in which robot hand 100 is disposed on floor 200. By lowering robot hand 100 in this state, it is possible to cause the fingertip of second finger member 4 that is located at the lower end of robot hand 100 to come into contact with floor 200 and to apply an external force to second finger member 4. By causing the distal end of second finger member 4 to come into contact with floor 200 at a diagonal, it is possible to apply an external force with which second finger member 4 rotates in the second rotation direction (the clockwise direction in the state illustrated in FIG. 5) with respect to intermediate member 3.

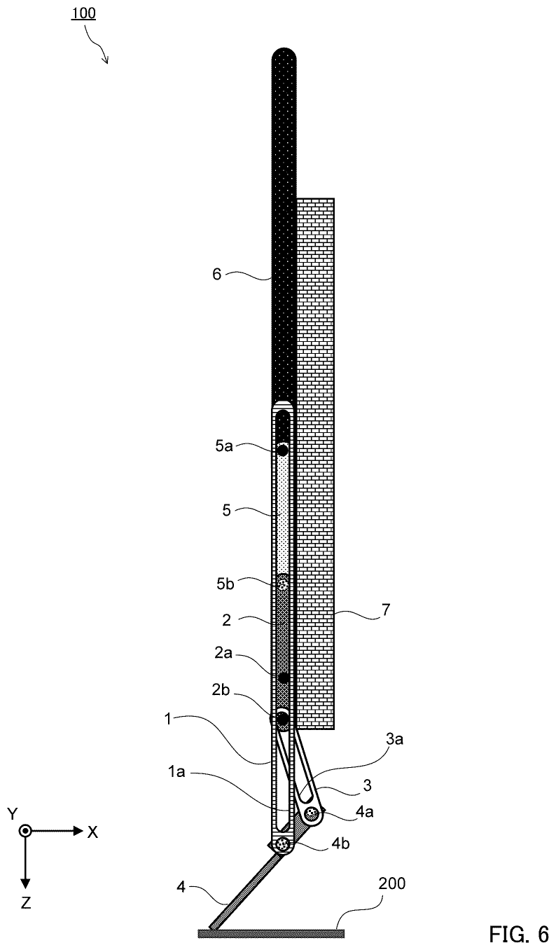

By applying such an external force, the second finger member 4 can be rotated in the second rotation direction (the clockwise direction in the state illustrated in FIG. 6) with respect to the guide member 1 around the pin 4b as the center of rotation as illustrated in FIG. 6.

Then, one end of second finger member 4, which is the end at which pin 4a is disposed, moves rearward (in the X direction). As one end of second finger member 4 moves, the lower end of intermediate member 3 moves rearward. That is, intermediate member 3 is drawn out rearward from a state of overlapping with guide member 1 in the left-right direction (Y direction). Note that, at this time, driver 6 may push down link member 5.

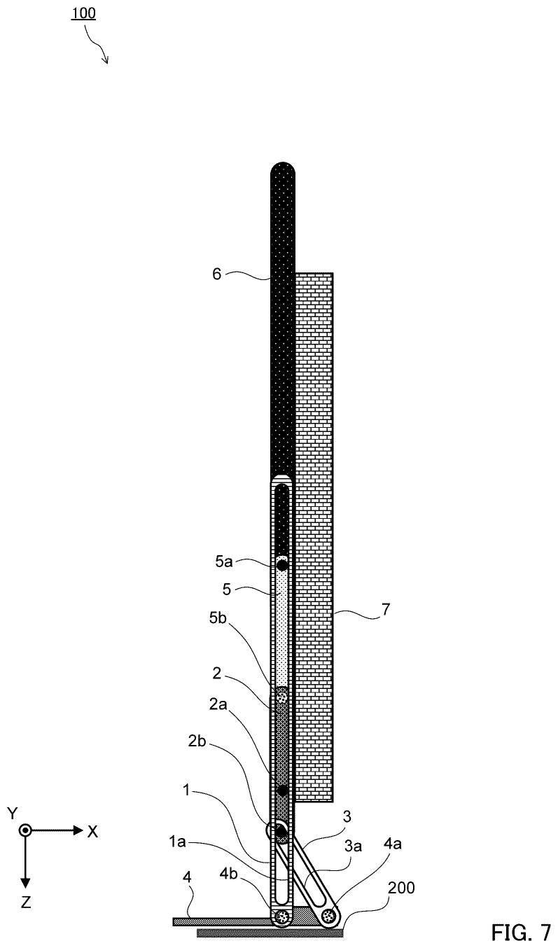

When robot hand 100 is further lowered from the state illustrated in FIG. 6 and driver 6 is relatively lowered with respect to guide member 1, robot hand 100 is set to a state illustrated in FIG. 7. That is, second finger member 4 is after completion of rotation, and is in contact with floor 200 in a state of extending in a direction orthogonal to guide member 1. Meanwhile, first finger member 2, is before the start of rotation, and is aligned with guide member 1, link member 5, and driver 6 on one straight line extending in the Z direction.

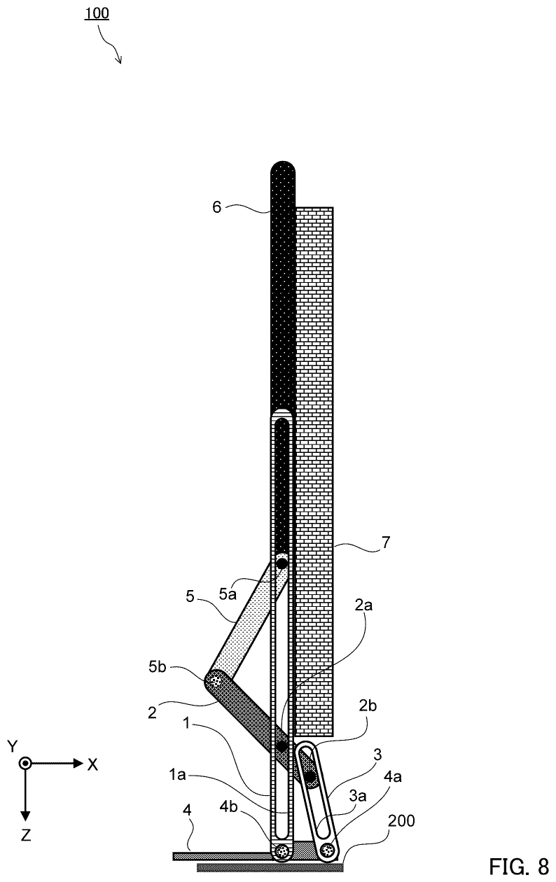

When driver 6 is further lowered from the state illustrated in FIG. 7, robot hand 100 is set to the state illustrated in FIG. 8. That is, first finger member 2 rotates in the first rotation direction (the counterclockwise direction in the state illustrated in FIG. 8) around first guide follower 2a as a rotation center.

When first finger member 2 rotates until the three line segments connecting third guide follower 5a, pin 5b, and second guide follower 2b draw a right-angled triangle, the rotation of first finger member 2 is completed. Note that, the state of robot hand 100 at this time is the same as the state of robot hand 100 illustrated in FIG. 3. By further lowering driver 6 from that state, it is possible to bring first finger member 2 closer to second finger member 4 and to grip the target object with first finger member 2 and second finger member 4.

### Still Other Operation Example

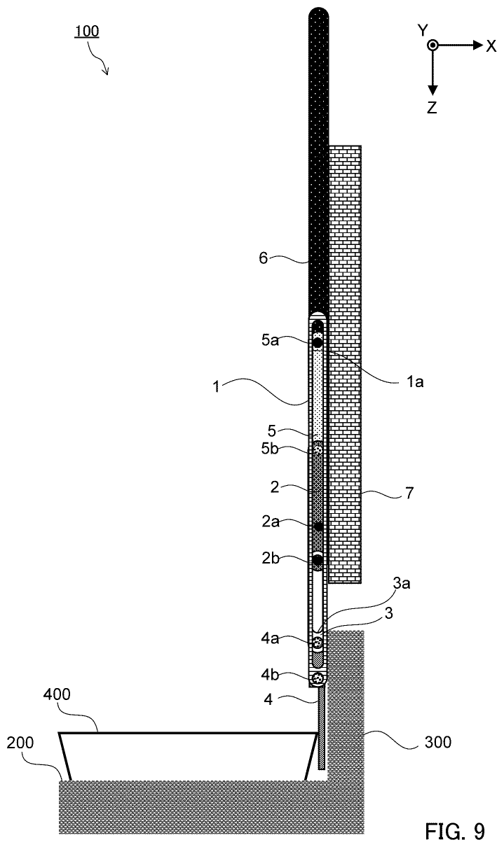

Next, further other examples of operations of robot hand 100 will be described with reference to FIGS. 9 to 13. When referring to FIGS. 9 to 13, the Z direction may be described as the up-down direction, the X direction as the front-rear direction, and the Y direction as the left-right direction.

As illustrated in FIG. 9, in the case where target object 400 is placed on floor 200 and close to wall 300, robot hand 100 can grip target object 400 by operating as follows.

First, as illustrated in FIG. 9, with robot hand 100 in the insertion mode, second finger member 4 is inserted into the gap between wall 300 and target object 400. When robot hand 100 is in the insertion mode, guide member 1, first finger member 2, intermediate member 3, second finger member 4, link member 5, and driver 6 are aligned on one straight line extending in the Z direction. That is, when set to the insertion mode, robot hand 100 can enter a narrow gap by reducing its own thickness in the X direction.

Subsequently, second finger member 4 is rotated in the second rotation direction (the clockwise direction in the state illustrated in FIG. 9) around pin 4b by pressing second finger member 4 against floor 200. At this time, the finger tip of second finger member 4 enters between floor 200 and target object 400.

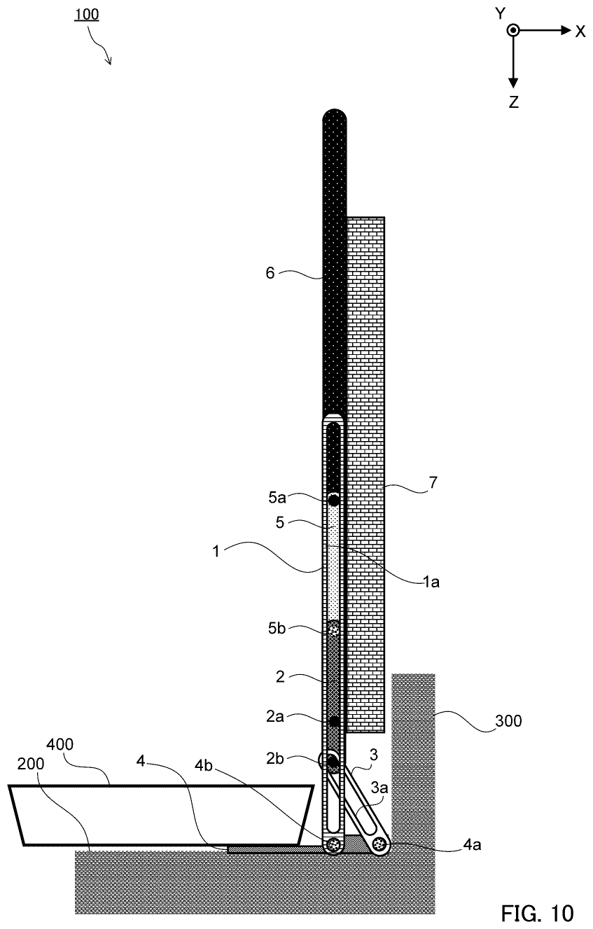

FIG. 10 illustrates a state in which the rotation of second finger member 4 is completed. Second finger member 4 extends in the front-rear direction below target object 400.

In the case where the center-to-center distance between the pins 4a and 4b is larger than the size of the gap between wall 300 and target object 400, guide member 1 moves in the forward direction (−X direction) with the connecting portion between second finger member 4 and intermediate member 3 in contact with wall 300. At this time, guide member 1 may push target object 400 in the forward direction.

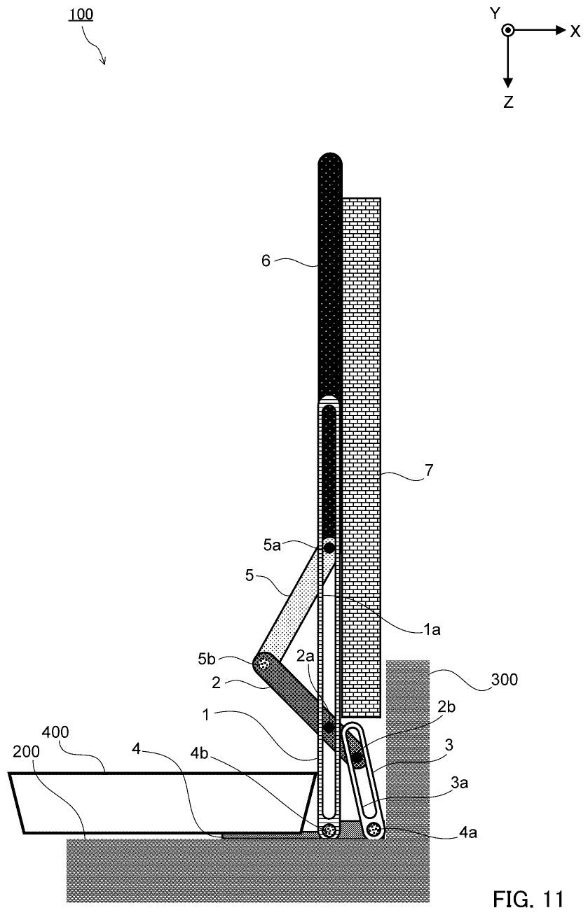

When driver 6 is further lowered from the state illustrated in FIG. 10, robot hand 100 is set to the state illustrated in FIG. 11. That is, first finger member 2 rotates in the first rotation direction (counterclockwise direction in the state illustrated in FIG. 11) around first guide follower 2a as a rotation center.

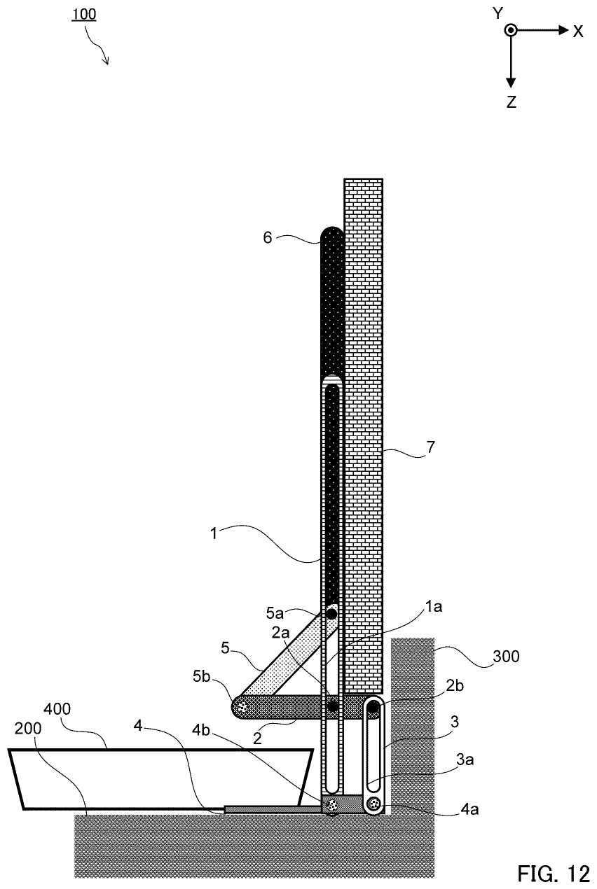

When driver 6 is further lowered from the state illustrated in FIG. 11, robot hand 100 is set to the state illustrated in FIG. 12. At this time, the three line segments connecting third guide follower 5a, pin 5b, and second guide follower 2b to each other draw a right-angled triangle. Thus, first finger member 2 cannot rotate any further. That is, the rotation of first finger member 2 is completed. At this time, first finger member 2 is in a state parallel to second finger member 4 and is located above target object 400.

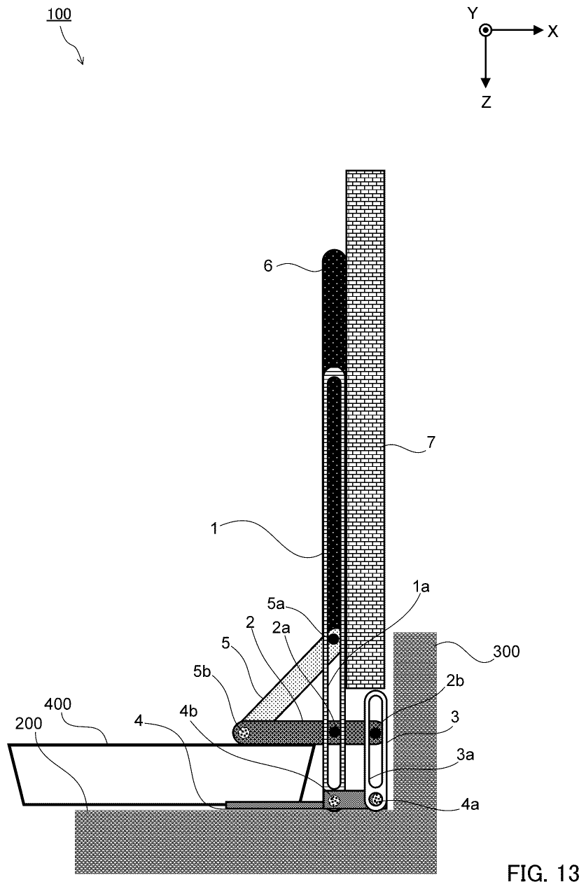

It is possible to grip target object 400 with first finger member 2 and second finger member 4 as illustrated in FIG. 13 by bringing first finger member 2 closer to second finger member 4 by further lowering driver 6 from the state illustrated in FIG. 12.

### Constraint of Second Guide Receiver

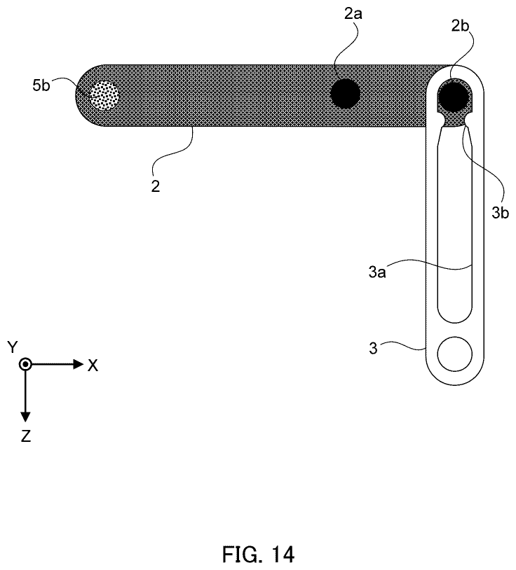

Next, with reference to FIG. 14 illustrating an enlarged view of first finger member 2 and intermediate member 3, the constraint of second guide follower 2b in second guider 3a will be described.

As illustrated in FIG. 14, intermediate member 3 includes a pair of protrusions 3b that protrude toward each other in second guider 3a. Each of protrusions 3b is formed of a material that elastically deforms. The distance between the pair of protrusions 3b is smaller than, for example, the diameter of second guide follower 2b, which is a pin having a cylindrical shape. Accordingly, in the state illustrated in FIG. 1 or 2, for example, second guide follower 2b cannot pass through between pair of protrusions 3b. That is, second guide follower 2b is constrained in second guider 3a.

On the other hand, as illustrated in FIGS. 3 and 14, when the rotation of first finger member 2 is completed and a strong force is applied to first finger member 2, one pair of protrusions 3b is elastically deformed by being pushed out by second guide follower 2b that enters between one pair of protrusions 3b. That is, the distance between the pair of protrusions 3b increases. In this manner, second guide follower 2b can pass through between the pair of protrusions 3b. That is, the constraint of second guide follower 2b in second guider 3a is released.

Note that, the constraint of second guide follower 2b in second guider 3a may be realized by another structure.

For example, second guide follower 2b may be elastically deformed instead of the pair of protrusions 3b.

Further, second guide follower 2b may have an elliptical shape having a major axis and a minor axis. In this case, second guide follower 2b is attached to first finger member 2 such that the short axis extends in the extending direction of first finger member 2, and the long axis extends in the direction orthogonal to the extending direction of first finger member 2. The length of the long axis is larger than the distance between the pair of protrusions 3b, and the length of the short axis is not greater than the distance between the pair of protrusions 3b. When second guide follower 2b has such a shape, second guide follower 2b cannot pass between the pair of protrusions 3b when first finger member 2 and intermediate member 3 are aligned in a straight line as illustrated in FIG. 1. That is, second guide follower 2b is constrained in second guider 3a. On the other hand, when first finger member 2 and intermediate member 3 are orthogonal to each other as illustrated in FIGS. 3 and 14, second guide follower 2b can pass through between the pair of protrusions 3b. That is, the constraint of second guide follower 2b in second guider 3a is released.

In the present specification, an elliptical shape includes not only a mathematical elliptical shape but also a semicircular shape, an egg shape, a shape with rounded corners such as a rectangular shape, and the like.

### Fixation of First Finger Member and Link Member

Further, when the rotation of first finger member 2 is completed and robot hand 100 is in the state illustrated in FIG. 3 or 12, first finger member 2 and link member 5 may be fixed to each other. That is, when three straight lines connecting first guide follower 2a, the connecting portion between the first finger member and the link member (that is, pin 5b), and third guide follower 5a draw a right-angled triangle, first finger member 2 and link member 5 may be fixed to each other.

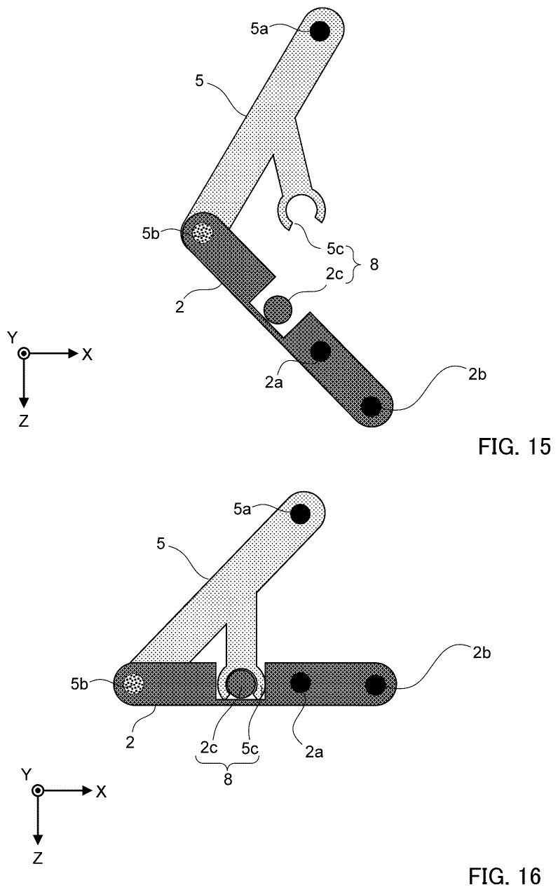

An example of fixing of first finger member 2 and link member 5 with respect to each other will be described with reference to FIGS. 15 and 16 illustrating enlarged views of first finger member 2 and link member 5. FIG. 15 illustrates a state in the mode transition, and FIG. 16 illustrates a state of the grip mode.

In the case where first finger member 2 and link member 5 are fixed to each other, link member 5 may include engager 5c, and first finger member 2 may include engagement follower 2c. Engager 5c and engagement follower 2c constitute fixer 8.

In the insertion mode or during the mode transition, engager 5c does not engage with engagement follower 2c. Accordingly, first finger member 2 and link member 5 are rotatable with respect to each other around pin 5b as a rotation center.

When the rotation of first finger member 2 is completed and the three line segments connecting first guide follower 2a, the connecting portion (that is, pin 5b) between the first finger member and the link member, and third guide follower 5a draw a right-angled triangle, engager 5c engages with engagement follower 2c. That is, fixer 8 functions such that first finger member 2 and link member 5 are fixed to each other.

By performing such fixing, it is possible to prevent the change in the angle of first finger member 2 with respect to link member 5. In turn, first finger member 2 can be brought closer to or moved away from second finger member 4 while preventing a state in which second finger member 4 is not orthogonal to guide member 1.

Note that, in the case where robot hand 100 includes fixer 8, stopper 7 may be disposed in a position shifted in the Y direction with respect to link member 5 (at least engager 5c). Such an arrangement makes it possible to prevent engager 5c from coming into contact with or colliding with stopper 7.

### Modification Example

The robot hand and the operation method thereof according to the present disclosure are not limited to the embodiments specifically described thus far, and include those to which various changes are made within the scope not departing from the spirit thereof.

For example, robot hand 100 according to the present disclosure may not include driver 6 and link member 5. It is possible to adopt a configuration in which first finger member 2 is directly attached to the robot arm to which robot hand 100 is attached, and the robot arm moves and rotates first finger member 2.

Further, robot hand 100 according to the present disclosure may include, instead of long driver 6, an actuator such as a motor for rotating pin 4b. Robot hand 100 can serve the function even by operating such an actuator so as to relatively rotate second finger member 4 with respect to guide member 1. That is, first finger member 2 and second finger member 4 may be disposed such that first finger member 2 and second finger member 4 are aligned in one straight line together with guide member 1, or that first finger member 2 and second finger member 4 are disposed orthogonal to guide member 1.

Further, robot hand 100 according to the present disclosure may include, instead of elongated driver 6, an actuator including a cam mechanism or the like that relatively moves intermediate member 3 in the X direction while maintaining a parallel posture with respect to guide member 1. Robot hand 100 can serve the function even by operating such an actuator so as to move intermediate member 3 from the position overlapping with guide member 1 to the position not overlapping with guide member 1. That is, first finger member 2 and second finger member 4 may be disposed such that first finger member 2 and second finger member 4 are aligned in one straight line together with guide member 1, or that first finger member 2 and second finger member 4 are disposed orthogonal to guide member 1.

Further, robot hand 100 according to the present disclosure may include link member 5 without including driver 6. It is possible to adopt a configuration in which link member 5 is directly attached to the robot arm to which robot hand 100 is attached, and the robot arm moves and rotates link member 5.

This application is entitled to the benefit of Japanese Patent Application No. 2022-88819, filed on May 31, 2022, the disclosures of which including the specification, drawings and abstract are incorporated herein by reference in their entirety.

### INDUSTRIAL APPLICABILITY

The present disclosure can be applied to an apparatus for realizing automation of a manufacturing process in various fields.

### REFERENCE SIGNS LIST

100 Robot hand
1 Guide member
1a First guider
2 First finger member
2a First guide follower
2b Second guide follower
2c Engagement follower
3 Intermediate member
3a Second guider
3b Protrusion
4 Second finger member
4a, 4b Pin
5 Link member
5a Third guide follower
5b Pin
5c Engager
6 Driver
7 Stopper
8 Fixer
200 Floor
300 Wall
400 Target object

1. A robot hand comprising:
a first finger member;
an intermediate member that is rotatably connected to the first finger member;
a second finger member that is rotatably connected to the intermediate member; and
a guide member that is rotatably connected to the second finger member and includes a first guider,
wherein the first finger member includes a first guide follower that is rotatably and movably disposed in the first guider.

2. The robot hand according to claim 1,
wherein a distance from a connecting portion between the first finger member and the intermediate member to the first guide follower is equal to a distance from a connecting portion between the intermediate member and the second finger member to a connecting portion between the second finger member and the guide member.

3. The robot hand according to claim 1,
wherein the intermediate member includes a second guider, and
wherein the first finger member includes a second guide follower that is rotatably and movably disposed in the second guider.

4. The robot hand according to claim 3,
wherein the first finger member and the intermediate member are configured to constrain a movement of the second guide follower in the second guider when the first finger member and the intermediate member are disposed along a straight line, and allow a movement of the second guide follower in the second guider when the first finger member and the intermediate member are disposed orthogonal to each other.

5. The robot hand according to claim 1, further comprising:
a stopper that comes into contact with the intermediate member to hold the intermediate member when the first finger member and the second finger member face each other.

6. The robot hand according to claim 1, further comprising:
a link member that is rotatably connected to the first finger member, and includes a third guider that is disposed rotatably and movably in the first guider,
wherein a distance from a connecting portion between the first finger member and the link member to the first guide follower is set to a dimension with which a right-angled triangle is drawable with three line segments connecting three points of the first guide follower, the connecting portion between the first finger member and the link member and the third guide follower.

7. The robot hand according to claim 6, further comprising:
a fixer that fixes the first finger member and the link member to each other when the three line segments are in a state of drawing a right-angled triangle.

8. An operation method for a robot hand, the method comprising:
disposing, along one straight line, a first finger member including a first guide follower, an intermediate member rotatably connected to the first finger member, a second finger member rotatably connected to the intermediate member, and a guide member rotatably connected to the second finger member and including a first guider;
rotating the first finger member with respect to the intermediate member in a first rotation direction while moving the first guide follower along the first guider; and
rotating the second finger member with respect to the intermediate member in a second rotation direction which is a direction opposite to the first rotation direction.

9. The operation method for the robot hand according to claim 8, further comprising:
disposing the first finger member and the second finger member parallel to each other.

10. The operation method for the robot hand according to claim 8, further comprising:
disposing the intermediate member and the guide member parallel to each other; and
bringing the first finger member closer to the second finger member.

11. The operation method for the robot hand according to claim 10, further comprising:
releasing constraint of a second guide follower included in the first finger member by the intermediate member; and
moving the second guide follower along a second guider included in the intermediate member.

12. The operation method for the robot hand according to claim 10, further comprising:
holding the intermediate member such that the intermediate member does not relatively move with respect to the guide member.

13. The operation method for the robot hand according to claim 8, further comprising:
disposing, along the straight line, a link member in addition to the first finger member, the intermediate member, the second finger member, and the guide member, the link member being a member that is rotatably connected to the first finger member and includes a third guide follower; and
rotating the link member in the second rotation direction with respect to the first finger member while moving the third guide follower along the first guider.

14. The operation method for the robot hand according to claim 13, further comprising:
fixing the first finger member and the link member to each other when three line segments connecting three points of the first guide follower, a connecting portion between the first finger member and the link member, and the third guide follower are in a state of drawing a right-angled triangle.

15. The operation method for the robot hand according to claim 8, further comprising:
applying an external force to the second finger member to rotate the second finger member with respect to the intermediate member in the second rotation direction.

16. The robot hand according to claim 3,
wherein the intermediate member includes a pair of protrusions that protrude toward each other in the second guider,
a distance between the pair of protrusions is smaller than a diameter of the second guide follower, and
the pair of protrusions or the second guide follower elastically deforms.

17. The robot hand according to claim 5,
wherein the stopper is made of a material that is elastically deformable.

18. The robot hand according to claim 6, further comprising:
a driver that is rotatably connected to the link member,
wherein by moving the driver in a direction away from the first finger member and the second finger member, an insertion mode state in which the guide member, the first finger member, the intermediate member, the second finger member, the link member, and the driver are aligned on one straight line is set.

19. The robot hand according to claim 18,
wherein by moving the driver in a direction toward the first finger member and the second finger member, a grip mode in which the right-angled triangle is formed is set.

20. The robot hand according to claim 7,
wherein the fixer includes an engagement follower of the first finger member and an engager of the link member.
